(19) United States
(12) Patent Application Publication
(10) Pub. No.: US 2014/0268352 A1
(43) Pub. Date: Sep. 18, 2014

(54) DEVICES FOR INTERLEAVING LASER BEAMS

(71) Applicant: TRUMPF Photonics, Inc., (US)

(72) Inventors: Thilo VETHAKE, Cranbury, NJ (US); Christoph TILLKORN, Villingendorf (DE); Stephan STROHMAIER, Franklin Park, NJ (US); Steffen RIED, Herrenberg (DE)

(73) Assignee: TRUMPF PHOTONICS, INC., Cranbury, NJ (US)

(21) Appl. No.: 13/835,956

(22) Filed: Mar. 15, 2013

(51) Int. Cl. G02B 27/10

(52) U.S. Cl. CPC G02B 27/10
USPC 359/618

(57) ABSTRACT

A device for interleaving a plurality of laser beams (2a, 2b . . . ) that includes laser emitters (3a, 3b, . . . ) arranged along a first direction (X) at a predetermined first distance (P1) from each other to generate laser beams that are aligned parallel and run at a first angle (α) to the first direction (X). Deflecting surfaces (7a, 7b, . . . ) deflect the laser beams so that the deflected laser beams run parallel to one another at a second angle (β). The first angle (α) and the second angle (β) are matched so that the optical path lengths (L1a+L1b, L2) of the laser beams between a first plane (X, Z) running along the first direction (X) in the beam path upstream of the deflecting surfaces and a second plane (B, Z) running along the second direction (B) in the beam path downstream of the deflecting surfaces are identical.

### 1. FIELD OF THE INVENTION

The present invention relates to devices for interleaving laser beams, comprising: a plurality of laser emitters that are arranged along a first direction at a predetermined first distance from each other to generate laser beams that are aligned parallel and running at a first angle to the first direction, and a plurality of deflecting surfaces for deflecting the plurality of laser beams, that deflecting surfaces are arranged along a second direction, different from the first direction, at a predetermined distance from each other,

### 2. DESCRIPTION OF RELATED ART

Such a device is described, for example, in WO 2010/138190 A1, and is used for beam alignment for generating an aligned two-dimensional array of parallel light beams. To achieve the parallel alignment, a plurality of reflectors is mounted on a beam alignment chamber, pitch (in the X direction) and yaw (in the Y direction) of each reflector being independently adjustable. A plurality of arrays of light sources is also provided, each of that is paired with a corresponding reflector to generate the two-dimensional array of parallel light beams. In one embodiment it is proposed that the optical path length of the light beams from each array or each light source to a common cylindrical collimating lens at the output of the beam alignment chamber be selected to be equal in order to correct the beam divergence for each array of light sources. This is achieved by arranging each light source at a different distance from the reflectors in order in this way to enable the condition of equal optical path lengths to be met.

An interleaving of laser beams is often implemented for the purpose of reducing the spacing of several laser beams aligned parallel to one another to increase the fill factor, for example, when coupling the laser beams into an optical fibre or similar. An increase in the fill factor can be achieved as result of the distance between adjacent laser beams before deflection being larger than the distance between adjacent laser beams after deflection. It has proved advantageous for the optical path lengths or the beam paths of the laser beams to a second plane, in that, for example, a focussing lens may be arranged, to be identical or substantially identical, since this improves the beam quality and allows the lateral far field to be controlled. If the optical path lengths are different, the residual divergence typically means that laser beams with different path lengths widen to a varying degree.

U.S. Pat. No. 6,124,973 describes an arrangement for shaping the beam cross-section of radiation to give it a specific geometry, wherein the radiation is emitted by several diode lasers, in particular arrays of diode lasers. The radiation of the diode lasers is deflected at respective reflecting surfaces to a predetermined common beam exit plane. To compensate for differences that may occur in the optical path lengths of the radiation of the diode lasers, it is proposed inter alia to select the distances between the diode lasers and the respective reflecting surfaces to be of different size.

DE 10 2010 038 572 A1 describes a device and a method for beam shaping having a plurality of light sources disposed adjacent to each other, each being associated with a first and a second reflection element. The beams of rays coming from the second reflection elements run parallel to each other and form a common emergent beam of rays, that may be coupled into an optical fibre by means of a focussing lens. The distance between a respective light source and the associated first (and second) reflection element may be chosen equal, whereby a compact beam shaping device may be provided.

DE 10 2010 031 199 A1 describes a device and a method for beam shaping, in that a plurality of laser elements disposed adjacent to each other, each of that emits a beam of rays, are mounted on a planar section on the upper face of a heat-conducting body. A reflection element is associated with each laser element. In one embodiment the distances of the individual laser elements from the associated reflection elements are selected to be different, in such a way that the optical path lengths from the beam exit opening of each laser element to a plane that runs perpendicular to the beam direction and lies behind the reflection elements are identical for all laser elements.

### SUMMARY OF THE INVENTION

The present invention provides devices, in particular of compact construction, for interleaving a plurality of laser beams, wherein the optical path lengths from a particular laser emitter to a common plane or to a common combining region in the beam path downstream of the deflecting surfaces are identical or substantially identical

According to a first embodiment, a device of the kind mentioned initially is provided in which the plurality of deflected laser beams run parallel to one another and at a second angle to the laser beams incident upon the deflecting surfaces, wherein the first angle and the second angle are so matched to each other that the optical path lengths of the laser beams between a first plane running along the first direction in the beam path upstream of the deflecting surfaces and a second plane running along the second direction in the beam path downstream of the deflecting surfaces, that second plane typically runs perpendicular to the beam direction of the deflected laser beams, are identical. The first plane and the second plane are arranged at an angle to each other that corresponds to the angle between the first direction and the second direction.

The inventors have recognised that for a given first distance between the laser emitters and a given, typically smaller, second distance between the deflecting surfaces or the deflecting points, and hence between the deflected laser beams, and for a given first angle, there is in each case (exactly) one second angle at that the condition of equal path lengths is fulfilled. In other words, for a particular pair of first and second distances there is a (normally unique) relation or functional dependency of the second angle on the first angle, for that the condition of equal path lengths is fulfilled.

The second distance, i.e. the distance between the deflected laser beams, should normally be constant for all laser beams. As a general rule this means that the first distances, i.e. the distances between the laser emitters, should also be the same size, since the condition of equal path lengths in the case of an identical first angle cannot normally be satisfied if the distances between the laser emitters are different: a given laser emitter, and a deflecting surface associated therewith, would in this case have to satisfy two different conditions for the second angle to fulfil the condition of equal path lengths for two immediately adjacent laser emitters disposed at different distances from the laser emitter.

The second angle is preferably different from 90°. Typically, in the prior art an angle of 90° is chosen as the second angle (deflection angle), with the result that the first angle, the first distance and/or the second distance are fixed and can no longer be freely selected. The use of second angles (deflection angles) other than 90° allows a device or arrangement adapted to the available installation space to be provided; in particular said device or arrangement can be of compact construction.

In one embodiment the plurality of laser emitters is mounted on a common support, the top face of that runs parallel to the first direction or parallel to the first plane. Typically, the laser emitters are mounted on the common support. The laser emitters can be designed or aligned to generate later beams that are aligned in the direction onto the deflecting surfaces and run at the first angle to the first plane, that is substantially consistent with the top face of the support or runs parallel thereto. The laser emitters can be in the form of, for example, laser diodes, and are arranged adjacent on the support, wherein the first direction corresponds to the direction in that the distance between the laser emitters on the top face of the support is measured. It is understood that in this case the emitter faces of the laser emitters are aligned perpendicularly to the beam direction of the laser beams and hence at an angle to the top face of the support.

In a development, the plurality of laser emitters is designed to emit laser beams that run parallel to the top face of the support. This development is an alternative to the above-described direct alignment of the laser beams onto the deflecting surfaces. The described alignment of the laser beams generated by the laser emitters is, for example, typical for DCB heat sinks. It goes without saying that in this case the laser beams emitted from the laser emitters have to be deflected from their emission direction to generate the laser beams aligned parallel and running at a first angle to the first direction.

In a further development, to generate the laser beams aligned parallel and running at a first angle to the first direction, deflecting elements for deflecting the laser beams that are emitted from the laser emitters and run parallel to the top face of the support are mounted on the support. The deflecting elements can be, for example, in the form of deflecting prisms, that may optionally serve simultaneously as collimating lenses, to collimate the laser beams (e.g. in the FA direction). Deflecting elements or deflecting prisms of this kind that are mounted on a support are described, for example, in WO 2010/051200.

In a development, the common support comprises a heat sink or is designed as a heat sink, in particular as a DCB heat sink. In this connection, the laser emitters, for example, in the form of laser diodes, can be mounted directly on a common heat sink, for example, by what is known as “direct copper bonding”, DCB. Cooling channels for water cooling of the laser emitters (laser diodes or diode bars) may be inserted, as required, in a DCB heat sink. In this manner the heat sink can be made especially thin, that allows a minimal pitch, i.e. a minimal distance between the individual laser emitters, since the low thermal resistance reduces a thermal cross-talk of the individual laser emitters and therefore the packing density can be increased.

In particular, with a (DCB) heat sink what is known as vertical stacking of laser emitters one above the other (i.e. in the FA direction) in the form of laser bars can advantageously also be implemented. Such a vertical stack can be cooled, in particular at the rear face, via a common DCB heat sink, thereby likewise enabling a high fill factor as the laser bars are stacked.

In a further embodiment, the first angle is more than 40°, preferably more than 70°, related to the first direction or the top face of the support. Such large angles of radiation from the top face of the support can be achieved, for example, in the case of vertically stacked diode bars or also in the case of diode bars arranged adjacent (horizontally), by providing suitable optical elements (deflecting elements). Large angles of radiation of more than 40° can be achieved, for example, if suitable microlenses for deflecting the beam, e.g. for deflecting by 90°, are mounted on the support.

In a further embodiment, the device additionally comprises a focussing device for focussing the deflected laser beams onto a common combining region. The combining region typically coincides with the focal point of the focussing device, that may comprise one or more transmitting or reflecting optical elements. The focussing device can be designed in particular as a focussing lens. The focussing can be used, for example, for coupling the laser beams into an optical fibre or the like. If a wavelength combining of the laser beams is to be effected, then the combining region is typically formed on an angle-dispersive optical element, as described in detail hereafter.

A second embodiment of the invention relates to a device of the kind mentioned initially, in that a respective deflected laser beam runs at a third angle to the laser beam incident upon the associated deflecting surface, so that the plurality of deflected laser beams is directed onto a common combining region, wherein the third angle is adjusted to the first angle in such a manner that the optical path lengths of the laser beams between a first plane running along the first direction in the beam path upstream of the deflecting surfaces and the combining region are substantially identical.

In this embodiment of the invention, the deflected laser beams are directed onto a common combining region, that typically corresponds to an (idealised) common point (focal point) at that the deflected laser beams meet. In this case, the condition that the optical path lengths of all laser beams between the first plane and the combining region are identical can typically not be complied with exactly, or only for the case of different first and second distances. “Substantially identical” in terms of this application is understood to mean a deviation of the optical path lengths that is defined as follows:

(Lₘᵢₙ−Lₘₐₓ)/(Lₘᵢₙ+Lₘₐₓ)<0.1%,

wherein Lₘᵢₙ denotes the optical path length of the laser beam of minimum optical path length and Lₘₐₓ denotes the optical path length of the laser beam of maximum optical path length from the first plane to the combining region. If the above condition is fulfilled, a harmonisation of the optical path lengths that is sufficient for most applications is achieved.

In a further embodiment, a respective third angle differs from a second angle by less than 5°, preferably by less than 3°, that is so adjusted to the first angle that the optical path lengths of deflected parallel laser beams between the first plane and a second plane that runs along the second direction in the beam path downstream of the deflecting surfaces and perpendicular to the beam direction of the deflected parallel laser beams, are identical.

To comply with the condition of identical optical path lengths between the first plane and the combining region as exactly as possible, it has proved advantageous for the third angles, that are used for alignment of the laser beams onto the common combining region, to differ from the second angle by the smallest possible amount, that ensures that the condition of equal optical path lengths is complied with when the laser beams are aligned parallel (see above). The third angle differs from the second angle typically only by a difference angle that is necessary to ensure the combining of the deflected laser beams onto the common combining region.

In a further embodiment, the combining region is arranged at a distance of at least one meter from the deflecting surfaces. The distance between the combining region and the deflecting surfaces is understood to mean the distance from the combining region of that deflecting surface arranged closest to the combining region, measured perpendicular to the second direction of the deflecting surface. The larger the distance between the combining region and the deflecting surfaces, the smaller, typically, is the variation of the third angle from the second angle, and the fewer the differences between the optical path lengths of the combined laser beams.

In a further embodiment, a difference angle between the third angles of adjacent deflecting surfaces is identical. This is particularly advantageous when the deflected laser beams are combined in wavelength, since during the combing at an angle-dispersive optical element with constant difference angles usually a constant wavelength distance between the wavelengths of the combined laser beams can be produced.

The combining region can be formed on a beam entrance surface of an optical fibre cable. In this case the laser beams enter the optical fibre cable as a combined laser beam, wherein the combining of the laser beams can be effected, for example, by the focussing lens described further above or by a suitable alignment of the deflected laser beams using the deflecting surfaces.

In a further embodiment, the device additionally comprises a combining device, in particular in the form of an angle-dispersive optical element, for spatial combining of the plurality of laser beams, that have different wavelengths, to form a combined laser beam having several wavelengths. In this case, the device is used for (dense) wavelength coupling. Spectrally sensitive elements, for example, in the form of cut-off filters, can be used as the combining device. An angle-dispersive optical element, at that the laser beams incident at different angles owing to their respective different wavelengths are combined to form a single laser beam with a plurality of different wavelengths, is frequently used as combining device. A reflecting or transmitting diffraction grating, that reflects or transmits the laser beams incident at different angles of incidence at a common emergent angle, is often used as the angle-dispersive optical element. An angle-dispersive optical element in the form, for example, of a prism can also be used as the combining device.

To generate laser beams with different wavelengths for the combining, a wavelength stabilisation is required. To achieve stabilisation, a feedback can be effected for each laser beam to be combined to stabilise the particular wavelength of the laser emitter associated with the laser beam. In this case, for example, what are known as volume Bragg gratings or grating waveguide mirrors, that reflect a part of the laser radiation back into the respective laser emitter, are used as feedback elements. The wavelength stabilisation can also be effected by means of a common feedback element, for example, by means of what is called a chirped volume Bragg grating, that allows several laser emitters to be stabilised to different wavelengths. It is also possible to carry out the feedback directly in a respective laser emitter, for example, during the use of what is called a “distributed feedback (DFB) laser”, in that the feedback element in the form of a grating structure is inscribed in the laser-active medium itself. The feedback element or the grating structure may also be arranged outside the laser-active zone, yet in a waveguide integrated in the same chip, as is the case with what is called a “distributed Bragg reflector” (DBR) laser. The spectral bandwidth of an individual wavelength-stabilised laser beam is in this case usually between approximately 0.1 nm and 0.4 nm.

In one embodiment, the combining region is formed at the combining device or at a feedback device for feeding a radiation component of the laser beams to be combined back to the laser emitters. The feedback can be effected by means of a feedback element or a feedback device that is arranged in the beam path of the combined laser beam. In this case a partially reflective output coupler element is often used as the feedback element, wherein the entire device as far as the output coupler element serves as resonator (known as an “external cavity laser”).

However, it is also possible to arrange a feedback element in the beam path between the laser emitters and the combining device, wherein the combining region is formed at the feedback element. In this case a partially reflective angle-dispersive optical element, in particular a partially reflective diffraction grating, is typically used as the feedback element, onto that the laser beams to be combined are aligned or focussed. Irrespective of the type of construction of the feedback element, the combining device itself can be in the form of an angle-dispersive optical element, to combine the laser beams.

Further advantages of the invention will be apparent from the description and the drawings. The features mentioned above and hereafter can likewise be used alone or jointly in any combination. The embodiments illustrated and described are not to be understood as an exhaustive list, but are merely of an exemplary nature for explanation of the invention.

### BRIEF DESCRIPTION OF THE DRAWINGS

FIG. 1 shows a schematic diagram of an embodiment of a device for interleaving a plurality of laser beams, wherein the laser beams are aligned parallel to each other before and after the deflection at a plurality of deflecting mirrors and are focussed by means of a focussing lens onto a beam entrance surface of an optical fibre cable,

FIG. 2 shows a schematic diagram of two deflecting mirrors, where a deflecting angle β is selected such that the two deflected laser beams have identical optical path lengths between a first plane and a second plane,

FIG. 3 shows a graph to illustrate the deflecting angle β as a function of an emission angle α that the laser beams form with a first plane that runs parallel to the top face of a common support,

FIG. 4 shows a schematic diagram of a further embodiment of a device for interleaving laser beams, that is designed for wavelength coupling of the interleaved laser beams, wherein the deflected laser beams are aligned onto a common combining region of a feedback device, and

FIG. 5 shows a schematic diagram of three deflecting mirrors, each with a different deflecting angle γ for approximate compliance with the condition of identical optical path lengths from the first plane to the common combining region.

### DETAILED DESCRIPTION

In the following description of the drawings, identical reference signs have been used for the same or functionally equivalent components.

FIG. 1 shows a device 1 for interleaving a plurality of laser beams 2a, . . . , 2n, that in the present example are generated by a corresponding plurality of laser emitters 3a, . . . , 3n in the form of laser diodes. The laser emitters 3a, . . . , 3n are arranged on a common support 4 in the form of a DCB heat sink. Two tubular connections, that serve to admit and discharge a cooling fluid into and out of the interior of the support 4 are mounted on the heat sink serving as support 4.

The laser beams emitted by the laser emitters 3a, . . . , 3n run in a first plane X, Z of an X, Y, Z co-ordinate system, that coincides with the top face 4a of the support 4 (or is arranged parallel thereto), specifically in the example shown in the negative X-direction. The emitted laser beams 2a, . . . 2n are collimated by means of prismatic collimation lenses 5a, . . . , 5n serving as deflecting elements in the FA direction and deflected so that they are emitted at an (identical) angle α to the first plane X, Z and to the top face 4a of the support 4 and are aligned parallel to each other.

As is also apparent from FIG. 1, the laser beams 2a, . . . , 2n are deflected at a plurality of deflecting devices in the form of deflecting mirrors 6a, . . . , 6n, or rather at the planar reflecting surfaces 7a, . . . , 7n thereof, so that they have a common beam direction A and are aligned parallel to each other. It is understood that the reflecting surfaces 7a, . . . , 7n could alternatively be mounted on a common main member, that serves as deflecting device. The deflected laser beams 2a, . . . , 2n are incident upon a focussing device in the form of a focussing lens 8, that in the present example is designed as a cylindrical lens. The plane of symmetry of the focussing lens 8 runs perpendicular to the plane of drawing of FIG. 1 (i.e. in the Z direction) and contains a second direction B that runs perpendicular to the beam direction A of the deflected laser beams 2a, 2n, i.e. the axial directions A, B, Z form an orthogonal co-ordinate system. The plane of symmetry B, Z of the focussing lens 8 is also referred to hereafter as the second plane B, Z.

In the following, an explanation is given using FIG. 2 of how identical optical path lengths of the laser beams 2a, . . . , 2n between the first plane X, Z in the beam path upstream of the deflecting surfaces 7a, . . . , 7n and the second plane B, Z in the beam path downstream of the deflecting surfaces 7a, . . . , 7n can be achieved. It should be noted here that the position of the first plane X, Z and the position of the second plane B, Z is arbitrary insofar as identical optical path lengths are maintained even in the case of a parallel offset of the first plane X, Y in the Y direction and in the case of a parallel offset of the second plane B, Z along the beam direction A of the deflected laser beams 2a, . . . , 2n, since here only the optical path length of the laser beams 2a, . . . , 2n overall increases or decreases.

It is assumed hereinafter that the position of the first plane X, Z in the Y direction coincides with the position from that the laser beams 2a, . . . , 2n directed onto the deflecting surfaces 7a, . . . , 7n start. The position in the Y direction can coincide with the position of the midpoints of the beam exit surfaces of the laser emitters 3a, . . . , 3n, when the latter direct the laser beams 2a, . . . , 2n directly onto the deflecting surfaces 7a, . . . , 7n (and accordingly the beam exit surfaces of the laser emitters 3a, . . . , 3n are aligned at an angle of α−90° with respect to the first plane X, Z). In the case of the arrangement shown in FIG. 1, the position of the first plane X, Z in the Y direction corresponds to the position of the beam exit surfaces (or the midpoints of the beam exit surfaces) of the collimation lenses 5a, . . . , 5n designed as deflecting elements (deflecting prisms).

As is apparent from FIG. 2 from the example of two adjacent laser emitters 3a, 3b, the associated laser beams 2a, 2b are deflected at the respective deflecting mirror 6a, 6b, or rather at the plane mirror surface 7a, 7b thereof, by an identical angle β. The laser emitters 3a, 3b are here arranged at a constant distance P1 apart (in the X direction), said distance P1 being 10 mm in the example shown in FIG. 1. The distance P2 (in the B direction) between the deflected laser beams 2a, 2b is 1.5 mm in the present example and corresponds to the distance between the deflecting surfaces 7a, 7b, or rather the distance P2 between the deflecting points 9a, 9b at that the laser beams 2a, 2b are incident upon the deflecting surfaces 7a, 7b respectively. It is understood that unlike what is shown in FIG. 2, the laser beams 2a, 2b directed onto the deflecting points 9a, 9b come not from the laser emitters 3a, 3b but from the deflecting elements 5a, 5b. As the deflecting elements 5a, 5b are offset merely by a constant amount (in the X direction) relative to the laser emitters 3a, 3b, that does not affect the following observations, for simplicity in FIG. 2 the laser beams 2a, 2b are illustrated as coming from the laser emitters 3a, 3b (that, as explained further above, is consistent with an alternative possibility for generating the laser beams 2a, 2b directed onto the deflecting surfaces 7a, 7b).

To achieve identical optical path lengths between the laser emitters 3a, 3b and the second plane B, Z (not shown in FIG. 2), it is necessary for the optical path length L2 from the second laser emitter 3b to the second deflection point 9b to be identical with the sum of the optical path length L1a from the first laser emitter 3a to the associated first deflection point 9a and the optical path length L1b from the first deflection point 9a to a point S, that is arranged in the beam path of the deflected first laser beam 2a at the level of the second deflection point 9b offset along the second direction B by the distance P2 to the second deflection point 9b.

For the given distance P1 between the laser emitters 3a, 3b and for the given distance P2 between the deflected laser beams 2a, 2b, there exists for a given first angle α (emission angle) (exactly) one second angle β (deflection angle) for that the condition of identical optical path lengths, i.e. L1a+L1b=L2, can be fulfilled. For the present example, in that P1=10 mm and P2=1.5 mm, the relation between the emission angle α and the deflection angle β, that permits identical optical path lengths, is illustrated in FIG. 3. For an emission angle α of 107°, the deflection angle β is about 140°. In FIG. 3 only deflection angles β that are greater than or equal to 90° are shown, since it is advantageous for the deflection angle β to be greater than 90°, as in this way the dimension or geometrical configuration of the device 1 can be optimally adapted to the available installation space.

In the example shown in FIG. 2, with a deflection angle β=140° and an emission angle α=107°, the optical path lengths are as follows: L1a=10 mm, L1b=16.67 mm, L2=26.65 mm, i.e. the condition of identical optical path lengths is satisfied.

On the basis of geometrical considerations the following equation is obtained for the correlation between the angles α, β and the distances P1, P2 from the drawing shown in FIG. 2:

[cos(α−90°)+sin(β−90°)]P1+P2=P1+sin(β−90°)/cos(α−90°)×P2 (1)

Using the equation (1), for a given P1, P2 a solution or a functional relation between the emission angle α and the deflection angle β can be specified, as is illustrated by way of example in FIG. 3.

To obtain identical optical path lengths between the first plane X, Z and the second plane B, Z for all laser beams 2a, . . . , 2n, it is advantageous if the distances P1 between the laser emitters 3a, . . . , 3n are constant, since different distances P1 give rise to different deflection angles β (see equation (1)).

Optionally, by varying the distance P2 between in each case two of the deflected laser beams 2a, . . . , 2n a configuration can be found that allows identical optical path lengths even when the distances P1 between the laser emitters 3a, 3 . . . , 3n are not constant. As a general rule, however, the distance P2 between the deflected laser beams 2a, . . . , 2n should be constant, so that such configurations are generally not desirable.

As is apparent from FIG. 1, the optical path lengths of the laser beams 2a, . . . , 2n to the focussing lens 8 are identical. The focussing lens 8 focuses the deflected laser beams 2a, . . . , 2n onto a common combining region (focus point F), that is formed at a beam entrance surface 10a of an optical fibre cable 10 that serves to transport the injected laser beams 2a, . . . , 2n for further use of the laser radiation in an arrangement (not shown), that may serve, for example, for the processing of workpieces. The optical path lengths of the laser beams 2a, . . . , 2n as they are focussed on the combining region F vary slightly from each other and therefore they reach the combining region or rather the focussing point F with minimal path length differences.

A combining of the laser beams 2a, . . . , 2n at the combining region F can also be achieved without a focussing device being required for that purpose. The device 1 from FIG. 1 can be used for the focussing, or rather for the alignment of the deflected laser beams 2a, . . . , 2n on the combining region F, the alignment of the deflecting surfaces 7a, . . . , 7n being modified in such a way that the deflected laser beams 2a, . . . , 2n are aligned on the common combining region F and meet thereon, as described hereafter by means of a device 1 as shown in FIG. 4. To achieve the combining on the combining region F, deflection angles γ₁, . . . , γₙ that vary from the deflection angle β as described in FIG. 1 are typically required. The requirement for the optical path lengths to be identical shall also be substantially fulfilled with the device shown in FIG. 4, i.e. the following shall apply:

(Lₘᵢₙ−Lₘₐₓ)/(Lₘᵢₙ+Lₘₐₓ)<01%,

wherein Lₘᵢₙ denotes the optical path length of the laser beam of minimum optical path length and Lₘₐₓ denotes the optical path length of the laser beam of maximum optical path length from the first plane X, Z in the beam path upstream of the deflecting surfaces 7a, . . . , 7n to the combining region F.

To fulfil this approximated condition, the deflection angles γ₁, . . . , γₙ should not vary significantly from the deflection angle β determined in conjunction with FIG. 2 and FIG. 3, i.e. the following should apply: |γᵢ−β|<5°, preferably |γᵢ−β|<3°, with i=1, . . . , n. FIG. 5 shows three laser emitters 3a, 3b, 3c, the deflection angles γ₁, γ₂, γ₃ of that are selected such that the associated deflected laser beams 2a, 2b, 2c are aligned on a common combining region F. In the example shown in FIG. 5, the second deflection angle γ₂ corresponds to the deflection angle β of the device described in FIG. 2, wherein the beam propagation direction of the deflected second laser beam 2b also coincides with the beam propagation direction A shown in FIG. 2. The middle laser emitter 3b represents a central laser emitter 3b of the device 1, around that typically an even number of further laser emitters 3a, 3c, . . . , are arranged at constant distances P2 along the second direction B.

The first and the third deflecting surface 7a, 7c in contrast have a different deflection angle γ₁=β+1° and γ₃=β−1°, to achieve the combining of the three laser beams 2a, 2b, 2c in the combining region F. It goes without saying that that choosing different deflection angles γ₁, γ₂, γ₃ results as a rule in slight variations from the requirement for identical optical path lengths of the laser beams 2a, 2b, 2c. Typically, in the present application the difference angle |γᵢ−γⱼ| between the deflection angles γᵢ, γⱼ of adjacent deflecting surfaces 7i, 7j is the same, that can be achieved by choosing the distances P2 between the reflecting surfaces 7a, . . . , 7n to be identical.

It goes without saying that the condition of identical difference angles can also be complied with if instead of an uneven number of laser emitters 3a, 3b, 3c, as shown in FIG. 5, an even number of laser emitters is used. In this case, for example, the middle laser emitter 3c and the corresponding deflecting mirror 6b could be omitted, that in the example illustrated would result in double the distance 2×P1 between adjacent laser emitters 3a, 3c and hence also double the distance 2×P2 between the remaining deflecting mirrors 6a, 6c.

Compliance with the condition of substantially identical optical path lengths, as defined further above, is typically possible when the distance L_{F} between the deflecting surfaces 7a, . . . , 7n, or rather the distance L_{F} between the deflecting surface 7n closest to the combining region F and said combining region F is sufficiently large, i.e. typically at least one meter. In this manner the difference angles |γᵢ−γⱼ| between the deflection angles γ₁, γ₂, γ₃, . . . and hence the differences between the optical path lengths are so insignificant that they are (virtually) negligibly small and are usually no larger than would be the case if the focussing lens 8 of FIG. 1 were to be used.

The requirement of identical difference angles |γᵢ−γⱼ| is advantageous in particular for the case in that a wavelength combining of the deflected laser beams 2a, . . . , 2n aligned on the combining region F is effected, as will be described in detail below by means of FIG. 4, in that a feedback device 12 in the form of a partially reflecting diffraction grating and a combining device 13 in the form of a transmitting diffraction grating are formed on a common main body 11 that is transparent to the different wavelengths λ₁, . . . , λₙ of the laser beams 2a, . . . , 2n. The partially reflecting diffraction grating 12 is typically arranged relative to the deflected laser beams 2a, . . . , 2n at the respective associated Littrow angle δ₁, . . . , δₙ to effect a wavelength stabilisation by feedback of the retro-reflected radiation component of the particular laser beams 2a, . . . , 2n into the respective associated laser emitter 3a, . . . , 3n.

The radiation component transmitted at the first diffraction grating 12 strikes the second diffraction grating 13 serving as combining device, is combined at said second diffraction grating substantially without dispersion to form a combined laser beam 14 and exits from the second diffraction grating at an exit angle φ of 90°, provided that the two diffraction gratings 12, 13 meet suitable conditions, not discussed in detail here.

It goes without saying that the first and second diffraction gratings 12, 13 can also be mounted on two separate main bodies and that instead of a feedback device 12 arranged in the beam path upstream of the combining device 13 a feedback device that is arranged in the beam path of the combined laser beam 14 can be used. In the latter case the feedback device can serve, for example, as out-coupling element for coupling out the combined laser beam 14 and may have a partially reflecting surface to reflect a radiation component back to the laser emitters 3a, . . . , 3n.

It goes with out saying that the device shown in FIG. 1 can also serve for wavelength combining, provided that the optical fibre cable 10 is replaced by another suitable optical component, in particular a combining device or a feedback device. The device shown in FIG. 4 can also be used in combination with an optical fibre cable 10 or the like, in that case a wavelength combining is dispensed with.

To summarise, an interleaving of laser beams whilst complying with the requirement for optically identical path lengths and a combining of the laser beams 2a, . . . , 2n onto a combining region F with approximately identical optical path lengths can be achieved in the above-described manner. In particular, the available installation space for the device can be fully exploited by adjusting the distances P1, P2 and the angles α, β and γᵢ. It goes without saying that not only laser diodes but also other kinds of emitters, for example, diode bars and/or diode stacks or array arrangements can be used as laser emitters 3a, . . . , 3n. The respective emitters can be both wideband emitters or multi-mode emitters and also single-mode emitters, that are particularly advantageous for specific applications.

1. A device for interleaving a plurality of laser beams (2a, . . . , 2n), comprising: a plurality of laser emitters (3a, . . . , 3n), that are arranged along a first direction (X) at a predetermined first distance (P1) from each other to generate laser beams (2a, . . . , 2n) that are aligned parallel and run at a first angle (α) to the first direction (X), and a plurality of deflecting surfaces (7a, . . . , 7n) for deflecting the plurality of laser beams (2a, . . . , 2n), that deflecting surfaces are arranged along a second direction (B), different from the first direction, at a predetermined second distance (P2) from each other,
characterised in that
the plurality of deflected laser beams (2a, . . . , 2n) run parallel to one another at a second angle (β) to the laser beams (2a, . . . , 2n) incident upon the deflecting surfaces (7a, . . . , 7n), and
the first angle (α) and the second angle (β) are so matched to each other that the optical path lengths (L1a+L1b, L2) of the laser beams (2a, . . . , 2n) between a first plane (X, Z) running along the first direction (X) in the beam path upstream of the deflecting surfaces (7a, . . . , 7n) and a second plane (B, Z) running along the second direction (B) in the beam path downstream of the deflecting surfaces (7a, . . . , 7n) are identical.

2. A device according to claim 1, in that the second angle (β) is different from 90°.

3. A device according to claim 1, in that the plurality of laser emitters (3a, . . . , 3n) is mounted on a common support, the top face of that runs parallel to the first plane (X, Z).

4. A device according to claim 3, in that the common support comprises a heat sink or is designed as a heat sink, in particular as a DCB heat sink.

5. A device according to claim 3, in that the plurality of laser emitters (3a, . . . , 3n) is designed to emit laser beams (2a, . . . , 2n) that run parallel to the top face of the support.

6. A device according to claim 5, in that to generate the laser beams (2a, . . . , 2n) aligned parallel and running at a first angle (α) to the first direction (X), deflecting elements (5a, . . . , 5n) for deflecting the laser beams (2a, . . . , 2n) running parallel to the top face of the support are mounted on the support.

7. A device according to claim 1, in that the first angle (α) is more than 40°, preferably more than 70°.

8. A device according to claim 1, further comprising a focussing device for focussing the deflected laser beams (2a, . . . , 2n) onto a common combining region (F).

9. A device for interleaving laser beams (2a, . . . , 2n) according to the preamble of claim 1, characterised in that
a respective deflected laser beam (2a, . . . , 2n) runs at a third angle (γ₁, . . . , γₙ) to the laser beam (2a, . . . , 2n) incident upon the associated deflecting surface (7a, . . . , 7n), so that the plurality of deflected laser beams (2a, . . . , 2n) are directed onto a common combining region (F), and
the third angle (γ₁, . . . , γₙ) is adjusted to the first angle (α) in such a manner that the optical path lengths of the laser beams (2a, . . . , 2n) between a first plane (X, Z) running along the first direction (X) in the beam path upstream of the deflecting surfaces (7a, . . . , 7n) and the combining region (F) are substantially identical.

10. A device according to claim 9, in that a respective third angle (γ₁, . . . , γₙ) differs from a second angle (β) by less than 5°, preferably by less than 3°, that is so adjusted to the first angle (α) that the optical path lengths (L1a+L1b, L2) of deflected parallel laser beams (2a, . . . , 2n) between the first plane (X, Z) and a second plane (B, Z) that runs along the second direction (B) in the beam path downstream of the deflecting surfaces (7a, . . . , 7n) are identical.

11. A device according to claim 9, in that the combining region (F) is arranged at a distance (L_{F}) of at least one meter from the deflecting surfaces (7a, . . . , 7n).

12. A device according to claim 9, in that a difference angle (|γᵢ−γⱼ|) between the third angles (γ₁, . . . , γₙ) of adjacent deflecting surfaces (7a, . . . , 7n) is identical.

13. A device according to claim 9, further comprising an optical fibre cable, at the beam entrance surface of that the combining region (F) is formed.

14. A device according to claim 9, further comprising: a combining device for spatial combining of the plurality of laser beams (2a, . . . , 2n) having different wavelengths (λ₁, . . . , λₙ) to form a combined laser beam having several wavelengths λ₁, . . . , λₙ).

15. A device according to claim 14, in that the combining region (F) is formed at the combining device or at a feedback device for feeding a radiation component of the laser beams (2a, . . . , 2n) to be combined back to the laser emitters (3a, . . . , 3n).

16. A device according to claim 15, in that the combining device and/or the feedback device are/is in the form of an angle-dispersive optical element.
